(19) United States
(12) Patent Application Publication
(10) Pub. No.: US 2026/0320080 A1
(43) Pub. Date: Oct. 15, 2026

(54) METHOD FOR GENERATING CHARACTER RELATION STRUCTURE AND SYSTEM THEREFOR

(71) Applicant: CJ OliveNetworks Co., Ltd., Seoul (KR)

(72) Inventors: Ye Eun CHUN, Seoul (KR); Tae Yoon HWANG, Seoul (KR); Se Un PARK, Seoul (KR); Byung Hak KIM, Seoul (KR)

(21) Appl. No.: 19/577,745

(22) Filed: Mar. 25, 2026

Related U.S. Application Data
(60) Provisional application No. 63/776,974, filed on Mar. 25, 2025.

(51) Int. Cl. G06F 16/28

(52) U.S. Cl. CPC G06F 16/285

(57) ABSTRACT

The present disclosure relates to a method for generating a character relation structure and a system therefor, and relates to a technology that extracts relations between characters from narrative text and generates them in a structured form.

### FIELD OF THE INVENTION

The present disclosure relates to the field of natural language processing and artificial intelligence technology, and more particularly, to a method for generating a character relation structure that extracts relations between characters from narrative text and structures them, and a system for the same.

In particular, the present disclosure relates to a technology for generating a structured character relation structure including explicit and implicit relations, roles, and group information between characters by dividing narrative text into a plurality of chunks, then generating a character relation graph based on a triple structure in the form of subject-predicate-object, and refining the graph by sequentially utilizing a plurality of large language models.

### BACKGROUND OF THE RELATED ART

With the recent rapid increase in the production of narrative content such as dramas, movies, and novels, the importance of technology that can quickly and accurately identify relations between characters appearing within the narrative is growing. In particular, in the content planning, production, and evaluation steps, it is essential to efficiently analyze complicated entangled relations between characters.

Conventionally, in order to analyze character relations, methods such as estimating relations based on co-occurrence between characters or constructing dialogue-based networks have been primarily used. However, since this method relies on whether the characters simply appear or talk within the same context, there is a problem in that a relation is determined to exist even when there is no actual interaction, and there is a limitation in that it does not sufficiently reflect the directionality or the emotional and contextual meaning of the relation.

Furthermore, while rule-based or manual relation extraction methods can provide high accuracy, they are inefficient in processing large amounts of narrative data and have a problem of poor scalability. Accordingly, automated natural language processing technology has been introduced, but existing automation methods also have low accuracy in pronoun interpretation, identification of the same person, and extraction of implicit relations, as well as difficulties in maintaining context in long narratives.

Recently, research is being conducted to extract relations between characters using large language models (LLMs). This method has an advantage of being able to extract more sophisticated relations based on contextual understanding capabilities, but a one-time processing method based on a single model may cause problems such as information loss in a long narrative structure, omission of implicit relations, and creation of false relations. In addition, there is a limitation in that the various names (given names, aliases, titles, etc.) of the same character cannot be accurately integrated, or structural information such as the character's role and affiliation group cannot be consistently reflected.

Therefore, there is a need for new technology capable of more accurately and systematically extracting relations between characters from narrative text, and generating them in a structured form by reflecting a plurality of information elements.

### CITATION LIST

### Patent Literature

(Patent Publication 1) 10-2026-0020162 (Feb. 10, 2026)

### SUMMARY OF THE INVENTION

The present disclosure has been contrived to solve the foregoing problems, and an object of the present disclosure is to provide a method for generating a character relation structure that can accurately and systematically extract relations between characters from narrative text and generate them in a structured form, and a system therefor.

According to one embodiment of the present disclosure, an aspect of the present disclosure is to provide a method capable of stably extracting relations between characters while minimizing a context disconnection problem occurring in a long narrative.

In addition, an aspect of the present disclosure is to accurately identify and integrate various names referring to the same character, thereby improving character identification accuracy.

In addition, an aspect of the present disclosure is to include not only explicit relations between characters but also implicit relations such as emotions and conflicts, thereby more precisely extracting relation information.

In addition, an aspect of the present disclosure is to reflect a character's role, importance, and affiliation group, thereby generating a structured character relation structure that goes beyond a simple relation graph.

In addition, an aspect of the present disclosure is to sequentially utilize a plurality of large language models to refine relation information for each step, thereby reducing errors occurring in single-model-based processing and improving the accuracy and completeness of relation extraction.

In addition, an aspect of the present disclosure is to eliminate unnecessary characters and generate a relation structure centered on the main characters, thereby facilitating narrative understanding.

In order to solve the foregoing problems, a method for generating a character relation structure performed by a device including a central processing unit and a memory may include (a) receiving narrative text; (b) dividing the text into a plurality of chunks; (c) extracting triple structures from the chunks to generate a character relation graph; (d) sequentially inputting the character relation graph into a plurality of large language models, but inputting an output of each large language model into a next large language model to refine character relation information; and (e) generating a character relation structure from the refined character relation information, wherein the triple structure is a structure in the form of subject-predicate-object.

Furthermore, in the method, the chunks of the step (b) may be units of tokens with a preset length.

Furthermore, in the method, the character relation graph of the step (c) may use an entity selected based on a subject and an object of the triple structure as a node, and use a relation selected based on a predicate of the triple structure as an edge.

Furthermore, in the method, the step (c) may further include (c-1) inputting the chunks into a pre-trained language model to extract triple structures.

Furthermore, in the method, the pre-trained language model used in the (c-1) step may be prepared through a training process including (c-1-1) dividing a plurality of training texts into training chunks; (c-1-2) inputting the training chunks into a large language model to extract training triple structures; (c-1-3) generating a training dataset including the training chunks and the training triple structures; and (c-1-4) training a preset language model using the training dataset.

Furthermore, in the method, the step (d) may further include (d-1) additionally inputting preset text into a plurality of large language models, wherein the preset text input by the step (d-1) includes at least one of a work plan, a summary, or character information.

Furthermore, in the method, the step (d) may further include (d-2) determining each node in the character relation graph as a main node or an auxiliary node according to its frequency of appearance or importance.

Furthermore, in the method, the step (d) may include (d-3) merging a plurality of nodes referring to the same character in the character relation graph, wherein the step (d-3) determines whether there is the same character based on at least one of the character's name, alias, title, job title, or summary information.

Furthermore, in the method, the step (d) may include (d-4) extracting at least one of an explicit relation or an implicit relation between a plurality of nodes from the character relation graph, wherein the explicit relation of the step (d-4) includes at least one of a romantic, family, friend, teacher-student, or colleague relation, the colleague relation of the explicit relation includes at least one of a superior, a peer, or a subordinate, and the implicit relation of the step (d-4) includes at least one of conflict, betrayal, help, sacrifice, dependence, revenge, resentment, love, longing, cooperation, deception, trust, protection, pressure, conspiracy, or vigilance.

Furthermore, in the method, the step (d) may include (d-5) removing an unnecessary node that does not affect a narrative from the character relation graph, wherein the unnecessary node in the step (d-5) includes a general title or a pronoun-like name.

Furthermore, in the method, the step (d) may include (d-6) extracting the role of each node in the character relation graph, wherein the role of the step (d-6) includes at least one of an occupation, position, or narrative-specific role.

Furthermore, in the method, the step (d) may include (d-7) classifying a plurality of nodes into groups in the character relation graph, wherein the group of the step (d-7) includes at least one of family, affiliation, occupation, or role.

Furthermore, in the method, the step (d) may further include (d-8) modifying an output of each large language model to match an input structure of a next large language model.

Furthermore, in the method, the step (d) may further include (d-9) verifying whether there is a refinement error for every output of a plurality of large language models.

Furthermore, in the method, the step (e) may further include (e-1) outputting the character relation structure in the form of a graph, but assigning at least one distinguishing mark such as color, size, or label to a node and edge.

In addition, in a character relation structure generation system including a central processing unit and a memory, the system may include a text input part that receives narrative text; a chunk division part that divides the text into a plurality of chunks; a graph generation part that extracts a triple structure from the chunks to generate a character relation graph; a character relation information refinement part that sequentially inputs the character relation graph into a plurality of large language models, but inputs an output of each large language model into a next large language model to refine character relation information; and a structure generation part that generates a character relation structure from the refined character relation information, wherein the triple structure is a structure in the form of subject-predicate-object.

Furthermore, in the system, the graph generation part may further include a triple structure extraction part that inputs the chunks into a pre-trained language model to extract a triple structure.

Furthermore, in the system, the character relation information refinement part may further include an additional input part that additionally inputs preset text into a plurality of large language models, wherein the preset text input by the additional input part includes at least one of a work plan, a summary, or character information.

Furthermore, in the system, the character relation information refinement part may include at least one of a node determination part that determines each node in the character relation graph as a main node or an auxiliary node according to its frequency of appearance or importance; a node merging part that merges a plurality of nodes referring to the same character in the character relation graph; a node relation extraction part that extracts at least one of an explicit relation or an implicit relation between a plurality of nodes from the character relation graph; a node removal part that removes an unnecessary node that does not affect a narrative from the character relation graph; a node role extraction part that extracts the role of each node from the character relation graph; and a node classification part that classifies a plurality of nodes into groups in the character relation graph.

Furthermore, in the system, the structure generation part may further include a distinguishing mark assignment part that outputs the character relation structure in the form of a graph, but assigns at least one distinguishing mark such as color, size, or label to a node and edge.

According to the present disclosure, narrative text may be divided into a plurality of chunks to generate a character relation graph based on a triple structure, and then refine it, thereby having an effect of stably extract relations between characters while minimizing context loss even in a long narrative.

In addition, a plurality of large language models may be sequentially applied to refine a result at each step, thereby having an effect of reducing errors occurring in single-model-based processing and improving the accuracy and completeness of relation extraction.

In addition, a relation structure reflecting a character's importance, role, and affiliation group may be generated, thereby having an effect of providing structured information that can effectively understand a narrative structure beyond simple connection relations.

In addition, various names referring to the same character may be integrated, thereby having an effect of improving the accuracy of character identification and preventing relation distortion caused by redundant nodes.

In addition, not only explicit relations between characters but also implicit relations such as emotions, conflicts, and cooperation may be extracted, thereby having an effect of more precisely and three-dimensionally expressing relations within a narrative.

In addition, unnecessary characters that do not affect a narrative may be removed, thereby having an effect of generating a concise and highly readable relation structure centered on core characters.

Besides, the generated character relation structure may be visually expressed, thereby having an effect of improving usability in various fields such as content analysis, script review, story understanding, and education.

In addition, a sequential multi-agent configuration according to the present disclosure has an effect capable of obtaining an improved result in terms of character recall and group matching accuracy compared to a method in which a single large language model performs all refinement tasks in a batch using the same input information.

### BRIEF DESCRIPTION OF THE DRAWINGS

FIG. 1 schematically illustrates an overall flow of a method for generating a character relation structure according to one embodiment of the present disclosure.

FIG. 2 schematically illustrates an overall sequence of a method for generating a character relation structure according to one embodiment of the present disclosure.

FIGS. 3A and 3B schematically illustrate a triple structure extraction process according to one embodiment of the present disclosure.

FIG. 4 schematically illustrates a preparation process of a pre-trained language model according to one embodiment of the present disclosure.

FIG. 5 schematically illustrates a process of additionally inputting preset text according to one embodiment of the present disclosure.

FIGS. 6A and 6B schematically illustrate a process of determining a main node or an auxiliary node according to one embodiment of the present disclosure.

FIGS. 7A and 7B schematically illustrate a process of merging the same character nodes according to one embodiment of the present disclosure.

FIGS. 8A and 8B schematically illustrate a process of extracting explicit or implicit relations between characters according to one embodiment of the present disclosure.

FIGS. 9A and 9B schematically illustrate a process of deleting an unnecessary node according to one embodiment of the present disclosure.

FIGS. 10A and 10B schematically illustrate a process of reflecting role information in a node according to one embodiment of the present disclosure.

FIGS. 11A and 11B schematically illustrate a process of reflecting group information in a node according to one embodiment of the present disclosure.

### DETAILED DESCRIPTION OF THE PREFERRED EMBODIMENT

Hereinafter, embodiments of the present disclosure will be described in detail with reference to the drawings. In assigning reference numerals to the elements of each drawing, the same elements have the same reference numeral whenever possible, even if they are marked in different drawings. In describing those embodiments, a detailed description of known related configurations and functions will be omitted to avoid unnecessarily obscuring the subject matter of the present disclosure.

Terms such as “comprising,” “having,” and “comprised of” as used herein do not exclude the addition of other elements unless specifically stated otherwise. In addition, even when an element is expressed in a singular form, it may be interpreted as including a plural form unless specified otherwise.

In describing the elements of the present disclosure, terms such as “first,” “second,” and the like are used to distinguish those elements from other elements and do not limit the order, number, or importance of those elements.

When describing a positional relation between elements, when two or more elements are described using terms such as “connected,” “coupled,” or “attached,” they may be directly connected to each other, or connected to each other with another element interposed therebetween. In this case, a case where an intermediate element is included should also be interpreted as being included in the scope of the present disclosure.

When describing a temporal flow, such as an operating or manufacturing method, even if terms such as “after,” “following,” or “next” are used, a non-continuous flow may be included unless “immediately” or “directly” is specified.

In addition, functional blocks marked in the drawings are only implementable examples, and various modifications can be made without departing from the concept and scope of the present disclosure. Function blocks may be implemented in hardware, software, or a combination thereof, and the present disclosure is not limited to a specific configuration.

The objects and technical configurations of the present disclosure and operational effects thereof will be more clearly understood through the accompanying drawings, and an embodiment of the present disclosure will be described below in detail. The embodiments disclosed herein should not be interpreted as limiting the scope of the present disclosure, and it should be understood that various applications and variations can be made.

In addition, herein, the terms “system” and “device” may be used interchangeably, and both terms should be understood as a computational system or device that executes a method for generating a character relation structure proposed herein.

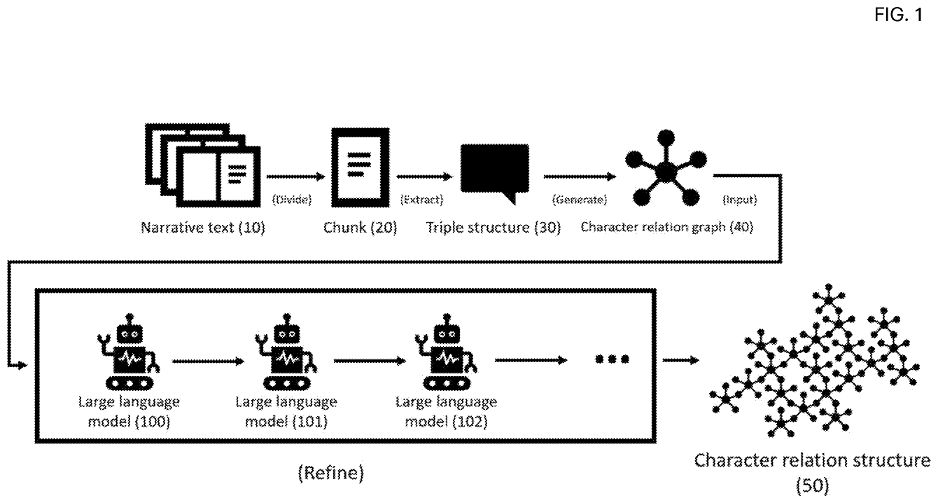

FIG. 1 schematically illustrates an overall flow of a method for generating a character relation structure that receives narrative text in the form of a plurality of documents as an input, extracts and refines relations between characters from the input step-by-step, and finally generates a structured character relation structure. Here, narrative text may include documentary data including characters and event developments, such as a drama script, a movie scenario, original novel text, a web novel serial, a plot for each episode, a work plan, a person introduction material, an episode summary, and a character setting guide. Therefore, narrative text illustrated in FIG. 1 implies that such input materials are not limited to a single file but can be provided as a combination of a plurality of source materials.

The device may first receive narrative text and divide the input text into units suitable for subsequent processing. Since long narratives often include a mixture of character title changes, omissions, use of pronouns, timeline shifts, and multiple point-of-view descriptions, it is preferable to process the entire text in units of chunks of a predetermined length rather than processing the entire text in a batch.

The chunks may be set by using a number of tokens, characters, sentences, paragraphs, scene transition criteria, episode criteria, speaker transition criteria, and the like, and divided into fixed-length chunks having hundreds of characters or a token length corresponding thereto. This approach allows relatively stable capture of interactions within each chunk while reducing the processing burden caused by long contexts.

Chunk division may be performed as simple cutting, but may also be performed to first preserve sentence boundaries or dialogue block boundaries, and, if necessary, some overlapping sections may be provided between adjacent chunks. By forming the chunks in this way, even if clues regarding the same person are scattered and present, they may be synthesized without omission in subsequent steps.

Then, a triple structure may be extracted for each divided chunk. The triple structure may consist of a combination of subject, predicate, and object, and may be utilized as a minimum unit of meaning that can mechanically deal with who has acted what to whom, or who is in what relation to whom within narrative text.

In a scene where a specific character helps another character, the agent of help may be extracted as a subject, the act of helping as a predicate, and the recipient of help as an object, and when a specific character is depicted as a family member of another character, an expression indicating the family relation may be normalized as the predicate.

The extraction of a triple structure may be performed by a pre-trained language model, and a separate language model may be fine-tuned based on response data for each chunk generated using an external large model, and then the triple structure may be produced using the fine-tuned model for an actual narrative input. This configuration allows the utilization of the meaning extraction capabilities of large-scale language models while reducing the risk of external leakage of sensitive narrative materials such as scripts.

Once triple structures are secured, the device may construct a character relation graph based thereon. In this case, entities corresponding to the subject and object become node candidates, and relation expressions corresponding to the predicate becomes edge candidates. When the same pair of characters appears repeatedly across a plurality of chunks, a connection strength between the corresponding nodes may accumulate, and accordingly, the character relation graph may be formed not as a simple connection graph, but as a weighted graph reflecting interaction frequency or narrative importance.

Here, since entities may be represented not only by proper nouns but also by job titles, aliases, family titles, organizational role names, and the like, the initial graph may be in a state of including a plurality of nodes referring to the same person. In addition, an edge of the initial graph may also retain the text of the descriptive expression exactly as it appears, or may retain a relation label that normalizes the synonymous expression.

For example, expressions with similar semantic fields, such as help, rescue, and care, may be integrated into a higher relation category, or hierarchical relations, such as superior, subordinate, senior, and junior, may be maintained as distinct labels. The graph formed in this step functions as a basic character graph for subsequent refinement, and represents an initial state before full interpreting a relation network of the entire narrative.

Then, the basic character graph is sequentially provided to a plurality of large language models or a plurality of agent-type processing steps.

In addition, a plurality of language models of the same or different series may be used step-by-step, and each model may have different prompts, different input schemas, and different determination criteria. For example, one step may focus on determining person identity, another on classifying relation types, and yet another on removing unnecessary nodes or assigning role names. In this case, the plurality of large language models may be physically different models, or may be configurations in which the same underlying model is divided into a plurality of roles and operated independently under different prompts and constraints.

Accordingly, rather than including all tasks in a single prompt at once, it may be implemented by breaking down narrative analysis tasks by function and refining each function sequentially. This is advantageous for reducing omissions, illusions, contradictions, and redundancies that commonly occur in a long narrative.

In particular, a process of format conversion and verification of intermediate results may be further included between each refinement step. That is, when the output of the preceding step does not match the input structure of the next step, the device may convert the output format to a character list, tabular data, markup structure, object list, key-value structure, graph serialization format, and the like.

For example, the same person pair information produced in the merging step may be reconstructed into an integrated character list so as to be referenced by the subsequent relation refinement step, and the relation data calculated in the relation extraction step may be arranged into a normalized schema so as to be easily reused by a role identification step or a group classification step.

In addition, a step of verifying whether there is a refinement error in the intermediate result may be further performed. The verification may be performed by checking empty node names, redundant edges for themselves, conflicting relation labels, unremoved alias nodes after merging, missing roles, redundant group assignments, and whether generic names are retained that do not match the context. If necessary, the device may perform a re-refinement loop by feeding the verification result back to the previous or same step of the model.

Finally, the device may generate a character relation structure based on refined character relation information, and output it as a documented result, a tabular result, a graphed result, or a combination thereof. In the graphed result, node sizes may be marked differently according to the importance, node colors or border shapes may be distinguished by the group or role, and explicit or implicit relations may be marked through labels of edges. In addition, a strength, frequency, continuity, and directionality of the relation may be visually expressed by using a thickness, line type, and color tone of the edge.

For example, when inputting a medical drama script, the device may receive the script for each episode and character introduction materials to extract interactions between persons in a triple structure, and distinguish and refine hierarchical relations, family relations, and emotional relations within the hospital organization. In this process, even if a specific person appears with both his or her real name and job title, they may be merged into the same person, persons unrelated to the core of the narrative, such as simple visiting patients, may be removed, and for the remaining persons, roles such as doctor, intern, chairman, or guardian as well as group information such as hospital teams, family units, or external organization units may be assigned.

Furthermore, in the case of a melodrama, not only the superficial marital or romantic relation but also implicit relations such as resentment, obsession, longing, betrayal, and protection may be reflected.

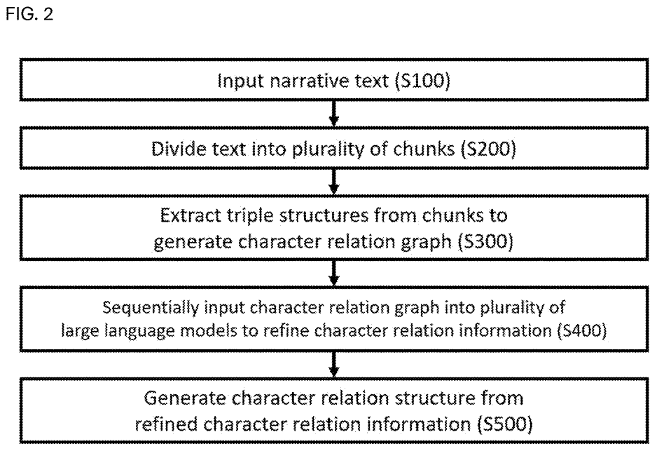

As illustrated in FIG. 2, a method for generating a character relation structure may be described around a procedure in which narrative text undergoes sequential processing steps to convert the form of an intermediate output, and is finally embodied into a character relation structure. FIG. 2, which is a flowchart that further subdivides the foregoing overall conceptual flow into procedural steps, shows a process in which input data does not remain in a simple text state but is gradually converted into a chunk set, a triple set, a character relation graph, refined character relation information, and a final character relation structure.

First, the device may receive narrative text, which may be received as it is in the original text, or may be a preprocessed text file, a database record, a document conversion result, or data collected through an application program interface. In addition, the device may further perform basic normalization in the input step, such as removing unnecessary control characters, unifying encoding, correcting paragraph boundaries, distinguishing between dialogue and stage directions, organizing speaker indicators, and assigning episode separation markers. This preprocessing is intended to prevent chunk boundaries from becoming excessively unstable in subsequent steps and to increase the identification accuracy of person names and relation expressions.

When chunks are formed, the device may extract a triple structure from each chunk to generate a character relation graph. The triple structure may be comprised of a subject, a predicate, and an object, and is used as a basic unit for formalizing interactions or relation clues between characters within narrative text. In this case, entities corresponding to the subject and object may be used as node candidates for the character relation graph, and relation expressions corresponding to the predicate may be used as edge candidates.

When similar triple structures are repeatedly extracted from a plurality of chunks for the same pair of characters, the weight or reliability of the edge may be set to increase, and when different expressions indicate the same semantic category, the relation labels may be normalized to integrate them into a single edge type. In addition, since aliases, job titles, titles, abbreviation names, family titles, and internal organizational titles can be extracted as separate entities at the time of initial graph generation, the graph formed in this step serves as a basic graph for subsequent refinement.

Then, the generated character relation graph may be sequentially input into a plurality of large language models to lead to a process in which character relation information is refined. This step is significant in that it is designed to perform a plurality of detailed tasks step-by-step based on an already formed basic graph, rather than collectively entrusting all determinations to a single large language model.

That is, the preceding model may perform tasks such as merging the same person, selecting important characters, and organizing relation candidates, and the succeeding model may perform more granular refinement such as classifying explicit and implicit relations, extracting roles, classifying groups, and removing unnecessary nodes. By configuring each model to be in charge of different specialized tasks in this way, it becomes possible to perform sequential refinement in which each step reviews and supplements the results of the previous step.

A sequential input to a plurality of large language models is not limited to a method of simply transferring the previous output string to the next model as it is. In the actual implementation, the output of each step may be modified to fit the input structure of the next step.

At any step, when a pair of the same person candidates is returned in the form of a natural language sentence, the device may convert it into a structured input form through regular expression-based extraction, parsing, key value mapping, standard markup conversion, or object list reconstruction. As another example, when the output of the relation extraction step is organized into the form of a table that includes explicit and implicit relations for each pair of character, it may be reorganized and input into a character-specific profile structure in the subsequent role identification or group classification step.

Such modification of the input structure is particularly useful when reconstructing a character relation graph at a plurality of expression levels. For example, the graph material structure itself may be stored as a machine-readable structure including a set of nodes, a set of edges, weights, and metadata, but a specific large language model may operate more stably when it is input as a natural language list or a sentence-type prompt.

In this case, the device may convert the same intermediate results into human-readable descriptive text, relation pair-listing text, structured tables, JavaScript object notation-like formats, markdown tables, or internal dictionary structures to fit the format requirements of each model. Conversely, when the output of the model is a natural language description, the device may reduce it back into an internal expression such as a node merge table, a relation label table, a role list, and a group map.

In addition, the presence of refinement errors may be verified for each output of the refinement step, and intermediate verification may be inserted after each detailed refinement step. The verification may include both format errors and content errors. Examples of the format errors include missing required fields, use of abnormal separators, blank character names, output of unallowed relation labels, incorrect field order, and return formats that do not match the structured schema. Examples of the content errors include reappearance of alias nodes that have already been merged, baseless generation of new persons that do not present in a graph, assignment of conflicting roles to the same person, redundant assignment to mutually exclusive groups, directional errors in explicit relations, classification mistaking transient events for persistent relations, and generation of orphan edges where references remain even after unnecessary nodes have been removed.

When the refinement is completed, the device may generate a character relation structure from the refined character relation information. This step is not simply a process of outputting the graph of the previous step as it is, but rather a process of instantiating a final structure by synthesizing the character set, merge results, relation labels, role information, group information, importance information, and the like, which are determined in the refinement step.

A plurality of names determined to be the same person may be integrated into a representative name and alias list, relations may be redefined as edges including directionality and type, and roles and groups may be combined into node metadata. In addition, the final structure may be implemented in the form of a visualization graph, or stored in the form of a character-specific summary table, a relation dataset, a graph data file, a documented report, and the like.

For example, when processing a medical narrative, the device may divide the input script and character introduction materials in units of chunks, and then extract interactions between doctors, interns, patient guardians, and hospital management members from each chunk into a triple structure.

In this process, even if the same individual is extracted separately by real name, job title, or title, they may be merged during the refinement step, and among medical staff, hierarchical and colleague relations may be reflected as explicit relations, and emotional relations such as competition, trust, protection, and resentment may be added as implicit relations. Additionally, one-time patients or background persons are removed, and a final structure may be generated in which roles and groups are assigned only to key persons.

As another example, in family-centered narratives, relations such as blood ties, marriage, parenting, conflict, and dependence may be more important criteria than occupation, and therefore, the refinement step may adjust relation priorities around family relations, and the final structure may also be expressed around family-based clusters.

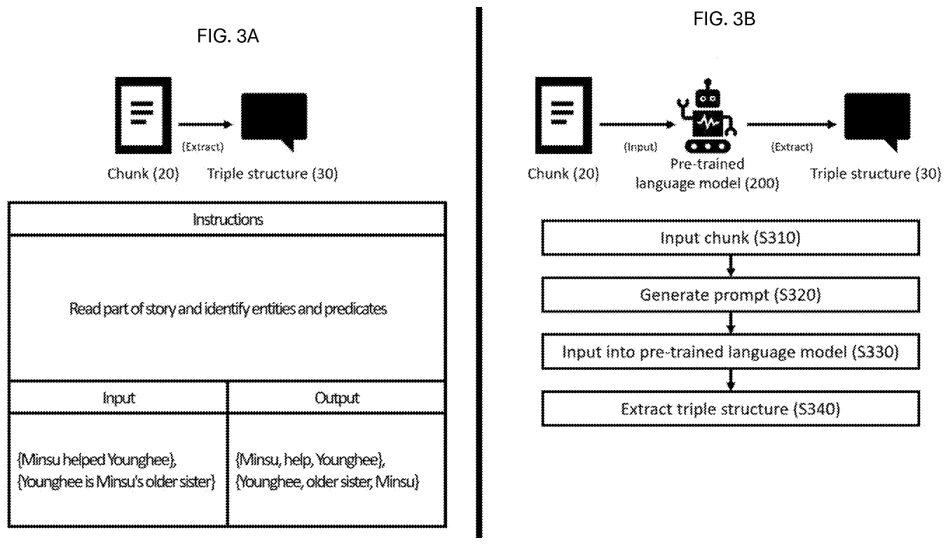

FIGS. 3A and 3B schematically illustrate a process of extracting a triple structure from a chunk. Extracting a triple structure from a chunk means organizing the meaning contained in a sentence into units of relations to convert them into the form of subject, predicate, and object. That is, it is a process of changing the persons, actions, or relations included in a narrative text into a structure that is easy for a machine to process.

For example, the sentence “Minsu helped Younghee” may be extracted in the form of “Minsu, help, Younghee” because Minsu is the subject of an action, “help” indicates the action or relation, and Younghee is the object. Furthermore, the sentence “Younghee is Minsu's older sister” may be organized into the form of “Younghee, older sister, Minsu” because Younghee is the subject, “is older sister” indicates the relation, and Minsu is the object.

As such, the triple structure expressing interactions or relations between persons scattered throughout the text in a predetermined format may subsequently be used as basic data for generating a character relation graph or refining a relation. That is, it may be understood as a process of structurally extracting “who does what to whom” or “who has what relation with whom” from each sentence, instead of processing various sentences included in a long narrative as they are.

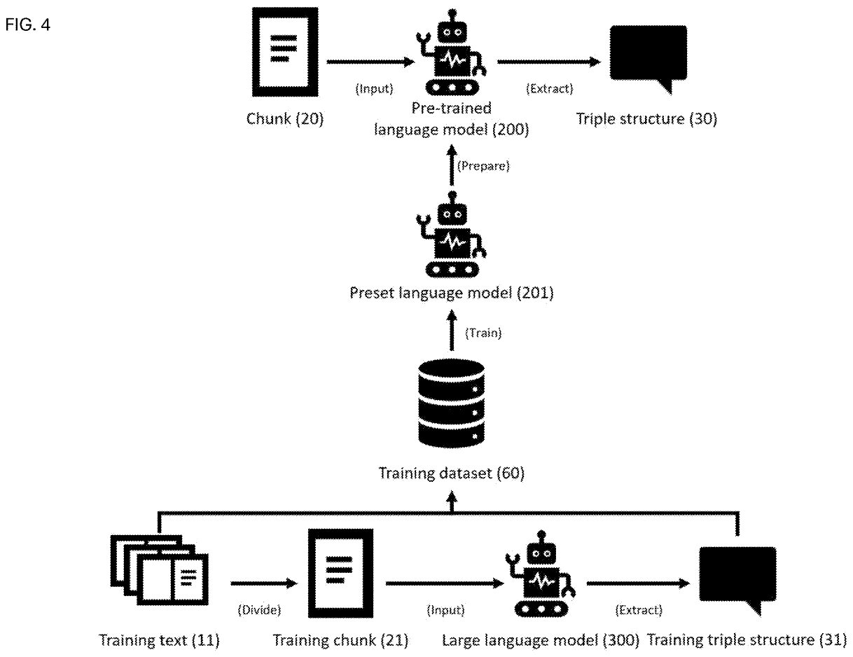

FIG. 4 illustrates a continuous system showing how a pre-trained language model for extracting triple structures can be prepared through data preparation and training procedures, and how it can be utilized in an actual narrative processing process after being prepared.

In extracting triple structures from narrative text, a method of utilizing a pre-trained language model has an effect of reducing the risk of external leakage of original narrative data. Typically, using APIs provided by large-scale language models may easily utilize high semantic understanding capabilities, but transmitting narrative text including copyright or business secrets, such as unpublished scripts for dramas, movies, and novels to external servers is often not allowed in the content industry. In particular, since protection of the confidentiality of the narrative is required for pre-broadcast drama scripts or pre-publication novel manuscripts, it is practically important to have a configuration that does not directly expose the original narrative to external APIs.

In order to solve this problem, in one embodiment of the present disclosure, a small specialized language model may be fine-tuned by utilizing the text of previous works released to the outside as training data, and triple structures may be extracted by using only that fine-tuned model without calling an external API at the time of the actual service. Specifically, reliance on external APIs occurs only during the step of generating training triple structures, where only text that does not require confidentiality, such as scripts or summaries of previously released works, is used. Therefore, new narrative source texts requiring confidentiality are not transmitted to the outside, but are input only into a finely tuned, pre-trained language model for processing.

By adopting this knowledge distillation method, it is possible to indirectly utilize the semantic understanding capabilities of a large-scale external language model, while preventing the original narrative data to be actually processed from leaking to the outside. This has a practical effect of allowing high-level triple structure extraction performance to be maintained while meeting the security requirements required by the content industry site.

For example, when dealing with a pre-broadcast drama script, the device may fine-tune a language model previously trained on a plurality of drama scripts and episode summaries that have been broadcast and released in the past, and extract a triple structure using only the pre-trained language model at the step where a new unreleased script is input, thereby processing the content of the unreleased script not to be transmitted to the outside.

The first thing to be prepared is training text. The training text may be a plurality of narrative documents including characters and event developments, and may include a drama script, an episode-specific plot, a movie scenario, a person introduction document, a work planning material, a novel body, a web novel serial manuscript, and a scene description. In this case, for training text, a material that sufficiently includes interactions between characters rather than a simple general document may be preferably selected.

When a primary target of processing is a narrative of a specific genre, materials similar to that genre in writing style, naming system, and relation expression may be included first. Particularly when dealing with drama scripts, script materials that include dialogue and stage directions for each episode may be advantageous, and supplementary materials such as character introductions or work outlines may also be utilized as part of the training text.

The training text may be stored in the form of a raw document and, if necessary, may be fed into the training step after undergoing preprocessing such as encoding standardization, special character cleanup, correction of unnecessary spaces, organization of dialogue divisions, and assignment of episode boundaries.

When the training text is prepared, the device may divide the training text into training chunks. The training chunks may be formed in units of preset lengths based on a number of characters or tokens, and may also be adjusted in consideration of sentence boundaries, dialogue boundaries, scene transition boundaries, and the like.

The large language model may interpret the meaning of narrative text and organize interactions between characters into subject, predicate, and object forms. For example, when there is a context in which a specific person protects, suspects, helps, or betrays another person, that person and action may be extracted as a subject, object, and predicate, respectively, and structural clues such as family relations, relations within an organization, and conflict relations may also be organized into a triple structure.

In this case, since the training triple structure serves as a reference output for subsequent training, it is preferable to maintain a consistent notation system as much as possible. That is, different expressions representing the same meaning may be normalized into an integrated predicate, and character names, when real names, aliases, and job titles are mixed, may also be organized into a single standard expression or a set of connectable expressions.

In addition, a plurality of training triple structures may be generated for a single training chunk. Since a plurality of people and a plurality of interactions can coexist within a single chunk of narrative text, the single chunk does not need to correspond to a single triple structure one-to-one.

For example, when family, cooperative, and conflictual relations are expressed simultaneously within the same chunk, a plurality of combinations of subject, predicate, and object may correspond to the chunk. In addition, if necessary, representative and auxiliary names identifying the character may be assigned to the subject and object, and the original and normalized expressions may be put down with the predicate. As such, the training triple structure functions not as a simple short sentence summary, but as a training target output that enables a preset language model to reproduce a similar structure upon receiving narrative chunks later.

The next device may generate a training dataset that includes training chunks and training triple structures together.

In addition, the training dataset may be divided into training and validation sets, and separated in units of works or episodes to reduce excessive redundant training of similar chunks of the same work. Furthermore, an additional quality verification procedure may be further included to remove or modify excessively ambiguous or incorrectly generated training triple structures.

When the training dataset is prepared, the device may train a preset language model using the training dataset. Supervised training or fine-tuning may be performed on a preset language model, and parameters may be adjusted to generate, when a training chunk is input, a training triple structure corresponding thereto. In this case, a loss function may reflect a difference between the output triple structure and the correct triple structure, and may be set to reduce errors such as missing character names, inversion of relation directions, and misclassification of predicates. In addition, in order to increase the stability of the output format, a separator token, a field order, a response length limit, and a sentence termination rule may be reflected together.

When a preset language model is trained, a pre-trained language model that can be used for extracting triple structures is prepared. In this case, a model version exhibiting the most stable performance among a plurality of training points may be selected, and adopted as an actual inference model only when the character name extraction accuracy or relation recall is above a reference.

After securing a plurality of Korean drama scripts and episode summaries, they may be divided into training chunks of a preset length, and each training chunk may be input into a large language model with excellent contextual understanding capabilities to generate interactions between persons as training triple structures in the form of subject, predicate and object.

Subsequently, a training dataset may be prepared by matching the training chunks and the training triple structures, and a pre-trained language model suitable for Korean may be fine-tuned to prepare a pre-trained language model with triple structure generation performance. Then, when actual chunks generated from a new drama script are input into the pre-trained language model, a triple structure that is a basis of the character relation graph may be stably produced.

In another example, modern office dramas and historical dramas may be separated to construct a separate training dataset, and pre-trained language models with different naming systems and relation expressions may be prepared for different genres. For example, since job title-centered expressions such as monarch, minister, concubine, crown prince, and subject are frequent in historical dramas, the model may be trained in a direction of strengthening the interpretation of the subject and object of these expressions, while in office dramas, the model may be prepared to better reflect expressions such as department names, job title names, project roles, and hierarchical relations.

In addition, additional procedures may be further included to improve the quality of the training dataset. After generating training triple structures, samples in which the same character is excessively scattered across different notations may be organized, or predicate expressions may be normalized to fit predefined relation categories.

If necessary, a person may review some samples to set quality references, and design automatic filtering rules based on those references. In addition, during training, early termination or performance monitoring using verification samples may be performed to prevent overfitting, and an optimal model may be selected by evaluating the format consistency of the output triple structure.

Meanwhile, additional supplementary steps may be included in the actual implementation. Sensitive information may be removed by performing de-identification processing before collecting training text, and after generating training triple structures, samples may be selected based on quality scores or low-quality samples may be excluded. In addition, through data augmentation, examples expressing the same relation in different writing styles may be added, and genre-specific balancing may also be performed to mitigate data distribution that is biased toward a specific genre.

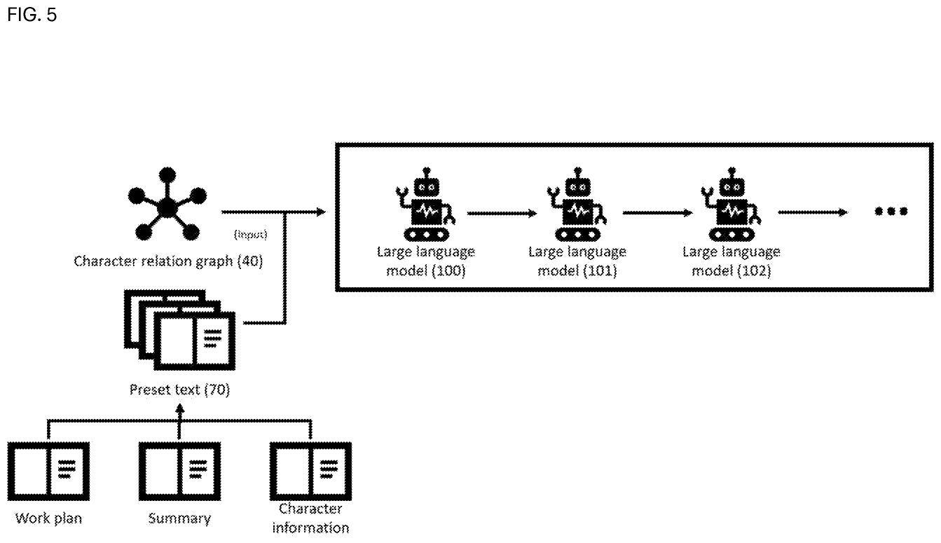

As illustrated in FIG. 5, in a process of refining character relation information, the accuracy and consistency of the refinement may be improved by not only using the original narrative but also by additionally inputting a separately prepared, preset text into a plurality of large language models.

The preset text may include at least one of a work plan, a summary, or character information. The work plan may be a document including the overall planning intention, worldview, core conflict structure, basic dynamics between persons, character backgrounds and settings, organizational or family system, and narrative direction of a drama, movie, or novel. The summary may be a document including a plot for each episode, an overview for each scene, a flow of major events, an overview of changes in relations between characters, and a turning point for each episode. The character information may be a document including information on a character name, nickname, title, job title, affiliation, family relation, role, whether he or she is a main person or a supporting person, person introduction phrase, initial relations between characters, and the like.

Each of the preset text may be stored as an independent document, managed as a single integrated explanatory statement or data package, and converted into a structured table form, a descriptive paragraph form, an item list form, or a markup format suitable for model input prior to the refinement step.

The reason why preset text is added is that the basic character relation graph is a result of aggregating triple structures extracted from the original narrative chunks, so it may not fully contain higher-level narrative information such as relation continuity, person identity, long-term conflict, role priority, and group representativeness.

For example, when the same person appears to be scattered across the original narrative by a real name, title, kinship title, or nickname, it may be difficult to identify him or her as a single person based solely on a basic graph. However, since the work plan or character information more explicitly organizes that person's background, occupation, family relation, alias, and connection to major events, a refinement model may refer to this supplementary information to more stably determine whether he or she is the same person.

In addition, since the summary organizes a flow of events and changes in relations for each episode, it may be usefully employed to determine whether a relation that appears to be an accidental contact in a single chunk is a continuous relation of confrontation or cooperation throughout the narrative.

The preset text may be equally and collectively provided to a plurality of large language models, or may be provided selectively and differentially depending on the function of each model.

For example, the character information and work plan may be provided first to a model in charge of merging the same person. In this case, a real name, alias, family title, job title, occupation, affiliation, and person description stated in the character information may be used as clues to determine identity, and the character background and relation settings described in the work plan may be utilized as reinforcement information.

For a model in charge of extracting relations, the summary and work plan may be provided with greater importance. The summary is advantageous in identifying the emotional line and conflict axis between persons within a flow of events, and the work plan may help identify long-term family structures, organizational structures, romantic relations, and competitive relations.

A model in charge of role identification may be provided at the core with character information and planning documents, and a model in charge of group classification may be provided with character information, summaries, and planning documents together to more accurately form family, organizational, occupational, and role-based groups.

Such an additional input may be provided only once at the start of the refinement process, but may also be reconstructed and provided for each refinement step to suit the purpose of that step.

For example, in the same person merging step, text that has been re-edited based on a comparison of a description of a single character may be provided, and in the relation extraction step, only a summary portion directly related to a specific character pair or relation candidate pair may be extracted and provided. In the role identification step, an excerpt focusing on person descriptions and occupation-related expressions may be provided, and in the group classification step, an edited version emphasizing family and affiliation relations may be provided.

As such, the preset text may be input as it is in the original text, but may also be provided in a shortened, aligned, standardized, excerpted, or rewritten form to suit the purpose and input limit of each big language model.

For example, a specific person may be stated as both a member of the protagonist's family and a member of a specific organization, or may be set as a collaborator on the surface but actually possess the potential to betray. Since this information may not be directly revealed in units of short chunks, the refinement model may refer to the planning document to maintain consistency at a higher level when merging the same person or selecting a type of relation.

In particular, when explicit and implicit relations exist simultaneously, a basic structure between people stated in the planning documents may serve as a criterion for determining the priority of relation labels. In addition, since the work plan may include clues to distinguish between the central and supporting persons of the narrative, it may also be utilized to determine the importance or set the central axis of the group.

When a summary is additionally input, it may play a significant role in reintegrating the scattered clues of a long narrative into a single context, as episode summaries concisely show cumulative actions and emotional line changes of each character.

For example, the original chunk may only capture a specific person's brief behavior of help, and mistaken for a one-time contact, but referring to the summary, it can be confirmed that the behavior is a relation of repeated protection or sacrifice. Conversely, even if a strong expression of conflict appears in a single chunk, the summary reveals that it is merely a temporary misunderstanding, and a long-term relation can be one of cooperation or trust. Therefore, the summary is very effective in identifying the continuity of relations, the direction of development, and the linkage with the central event.

In addition, when episode summaries exist, the refinement model may distinguish between relations limited to specific episodes and those maintained throughout the narrative, and may assist in determining which relations to retain as core relations in the resulting structure.

In an example in which character information is additionally input, identification and role information for individual characters are intensively provided. The character information may include real name, alias, nickname, title, job title, family relation, organization affiliation, occupation, age range description, personality trait, main narrative function, and the like. Among them, real name, alias, job title, and family title may be directly used for merging the same person, and occupation and position information may be directly used for role identification and group classification.

In addition, when information on whether he or she is a main person or a supporting person, or a leading or supporting group is included, the device may use this as an initial importance value or a refinement priority.

The preset text may be comprised of a single composite input along with a character relation graph to be refined.

The device may combine a related paragraph of the work plan, a related summary of the summary, and a related item of the character information into a single prompt or input structure, together with a node list, a relation candidate list, and interaction frequency information extracted from the character relation graph.

For example, in the same person merging step, a character description phrase suggesting that “Professor Cha” and “Cha Young-min” are the same person may be provided, and in the relation extraction step, a planning document phrase stating that a specific pair of persons is family and an emotional change sentence in the episode summary may be provided together.

For example, when generating a character relation structure for a medical drama, the work plan may include an organizational structure between the emergency medicine and thoracic surgery departments, power dynamics between hospital management members and medical staff, and basic settings for the protagonist and supporting persons. In the summary, surgical events, accidents, conflicts, cooperation, confidential exposure, and family problems for each episode may be summarized. In the character information, the occupation, affiliation, and alias of each person, such as a doctor, intern, professor, hospital director, foundation official, and patient guardian, may be organized.

The device may additionally input these preset texts into relation refining models to more accurately determine hierarchical relations, hidden interests, emotional lines of protection and vigilance, and whether or the real name and job title of the same person are merged.

As another example, in a family-centered narrative, blood ties and marital structures between persons may be organized in the work plan, the conflict axis and reconciliation process for each episode may be described in the summary, and each character's position and alias within the family may be included in the character information. In this case, the refinement model may form a character relation structure based on long-term family and emotional relations, without being swayed by simple title expressions.

The refinement model may also include a configuration to adjust the reliability or priority of preset text. The work plan accurately may reflect the initial narrative intention but differ slightly from the actual development, the summary may reflect a flow of events but omit specific relation names, and the character information may effectively illustrate the identity of the person but not fully capture dynamic changes in the relations. Therefore, the device may vary the reference priority depending on the purpose of the refinement step.

The character information and planning documents may be referenced first in merging the same person, the summary and planning documents may be referenced in parallel in extracting relations, and character information may be referenced first in identifying roles.

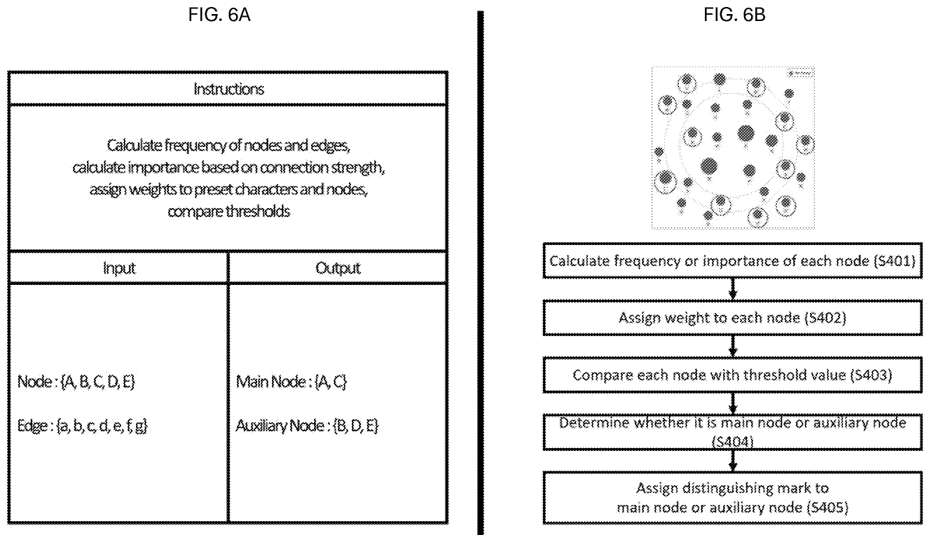

FIGS. 6A and 6B illustrate an exemplary process of selecting a character that is central to narrative understanding and a character that needs to be tracked accordingly among a plurality of nodes included in a character relation graph, and determining each node as a main node or an auxiliary node.

The device may calculate an evaluation value for each node included in a basic character relation graph based on a frequency of appearance or importance. Here, the frequency of appearance may be understood as a concept that includes a number of times a specific character is mentioned within a narrative text, an extent of repeated occurrences across a plurality of chunks, a number of interaction partners, and a degree to which he or she is centrally mentioned in the episode summary or scene description.

The importance may not be determined solely by simple frequency, but may be calculated by reflecting a connection strength with other nodes, a linkage to key events, a proximity to a main person, whether he or she is a central person as assigned in the work plan or character information, and an influence on the development of the narrative.

Therefore, surrounding people who perform only temporary functions, even if frequently mentioned, may have a relatively low importance, and conversely, people who are closely connected to a main person and repeatedly involved in a narrative turning point, even if a number of appearances itself is not large, may have a high importance. As such, the determination at this step is not limited to the simple counting of occurrences, but may be implemented in a direction that considers centrality and contextual weight within the narrative network together.

A person who is a key party to a narrative conflict, a leading person, or a recurring center point in a narrative structure may be determined as a main node to be marked as a relatively large node, and a person who is closely connected to the leading person but does not directly lead the development of the narrative may be determined as an auxiliary node to be marked as a smaller node. Additionally, a person in a more peripheral position may be marked as a smaller node to indicate that this step is a screening step prior to complete removal.

In addition, the determination of a main node or an auxiliary node may be performed by various combinations of criteria. Even among characters with a high frequency of appearance, when there are a plurality of relation edges with a main person and those relations correspond to narratively core types such as family, colleagues, lovers, conflict partners, protection targets, or competitors, a possibility of being determined as a main node may increase.

On the other hand, when it is closely related to a specific main person but the scope of the relation is limited and does not form an independent axis of event development, it may be determined as an auxiliary node. In another example, a person grade stated in the work plan or character information, whether he or she is a leading or supporting role, a length of person introduction, and a degree of repeated references in the summary may be reflected in the initial importance.

In this case, even a person who appears insignificant based solely on the original text may have a higher priority when established as a central person during the planning step. Conversely, functional persons who have a large amount of dialogue or occurrences but are irrelevant to the core of the narrative may be maintained as auxiliary nodes or peripheral review nodes.

For example, when processing early episodes of a medical drama, emergency room doctors, residents, hospital management members, and the protagonist's family members may be determined as main nodes because they repeatedly appear as central axes in the work plan and summary.

In contrast, patient guardians, one-time counselors, and temporary administrative staff who appear only in specific events may be determined as auxiliary nodes or candidates for subsequent removal, even if they have a frequency of appearance. However, exceptionally, even when a specific patient or guardian initially appears as a surrounding person, if he or she consistently influences the protagonist's narrative change or conflict structure in subsequent episodes, he or she may be promoted to an auxiliary node or a main node by connection strength and importance propagation.

As another example, in a family-centered narrative, spouses, parents, children, siblings, and parties in marital relations may be determined as main nodes, and relatives, colleagues, and friends who repeatedly conflict with them, share secrets, or serve as links in events may be determined as auxiliary nodes.

In addition, a result of determining the importance may be reused as an input condition for a subsequent refinement step. When extracting explicit and implicit relations, a relation between a main node and an auxiliary node may be first refined, and more detailed role names may be assigned to the main node and the auxiliary node during the role identification step.

In the group classification step, the structure may be simplified by a method of determining a group name around the main node and subordinating the auxiliary node to that group. Furthermore, in the final visualization step, a larger size, a more prominent label, or a central placement may be assigned to the main node, and the auxiliary node may be represented in a relatively simplified form.

The determination of the main node or the auxiliary node may be performed by using a graph-based importance propagation algorithm. For example, an algorithm that repeatedly propagates and updates an importance along the connection structure in the graph, starting from the importance of a seed node specified by a user, such as Personalized PageRank (hereinafter PPR), may be used.

Specifically, the device may receive information on a leading character corresponding to the protagonist of the narrative and a significant supporting character from the user, and assign a relatively high initial importance to a node corresponding to the leading character and a relatively low initial importance to a node corresponding to the supporting character, respectively. As such, starting from the initial importance based on user-specified information, the device may propagate the importance to an adjacent node along the connection structure in the character relation graph, and select a node that has acquired an importance score above a preset threshold as a candidate for the main node or the auxiliary node.

The device may repeatedly perform the screening process, rather than limiting it to just one time. For example, by newly setting the updated importance for nodes identified in the first screening step, and repeating the process of propagating the importance again starting from those nodes, characters closely connected to the main person may be discovered step-by-step even if a direct frequency of appearance in the initial episodes is low. The final character list may be comprised of a union of nodes selected in a plurality of iteration steps in this way.

This method has an advantage of being able to more stably capture, when there is a character closely connected to a main person narratively even if a frequency of appearance is low in early episodes of the narrative, that character unlike ranking methods based on simple appearance counts or a number of edge counts. On the other hand, when core characters already appear frequently in early episodes, a selection method based on a number of simple connected edges may also be effectively utilized, thereby allowing an appropriate algorithm to be selectively applied depending on the structural characteristics of the narrative.

For example, when a protagonist's family member appears briefly without dialogue in an early episode of a medical narrative, a number of edges of that node may be low, but if the person is stated as closely related to the protagonist in the work plan, he or she may be included as a candidate for selection based on the initial importance setting. Conversely, a patient assistant person appearing multiple times in a one-time treatment scene may be processed below a threshold even if he or she has a relatively high number of edges, due to a weak importance connection with the main person.

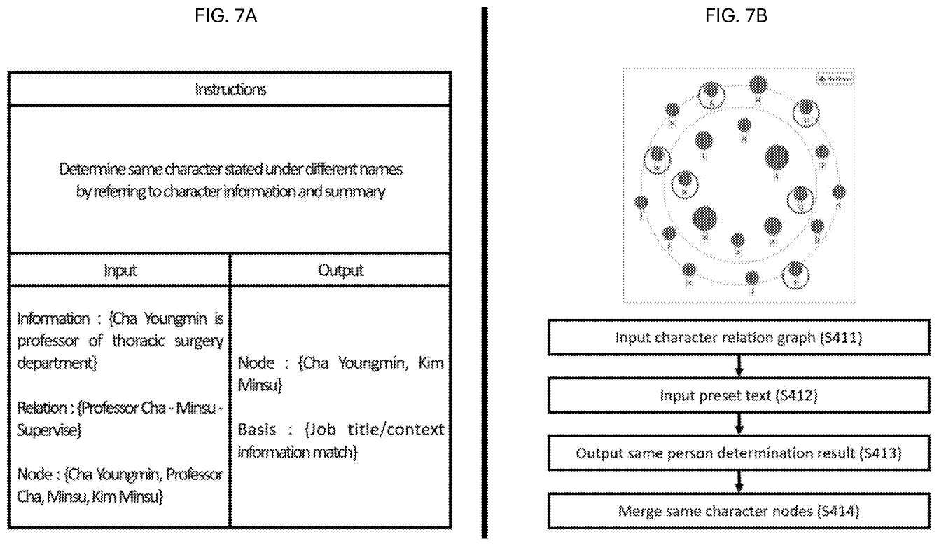

FIGS. 7A and 7B illustrate a process of determining nodes that refer to substantially the same character among a plurality of nodes included in a character relation graph, and integrating those nodes into a single representative node.

For each node constituting the character relation graph, the device may determine whether different nodes actually indicate the same character. This determination is not limited to a case where the node name strings match exactly.

In narrative text, since the same person may be repeatedly referred to as a real name, a combination of surname and given name, an abbreviated form using only part of the name, a title including a position, a kinship title, a nickname, an alias, or a treatment expression that varies depending on the situation, the text includes a configuration that determines the same personality beyond such superficial differences.

For example, when a scene in which a specific person is described as a real name coexists with a scene in which he or she is mentioned only by a title, or even when a real name is stated in a character introduction document but described only by a nickname in a summary, the device may determine identity by synthesizing the similarity of names of those expressions, consistency of roles within the context, relation patterns with surrounding people, affiliation information, family relations, and summary information.

In addition, not all nodes are subject to merging, but identity determination may be selectively performed on some nodes that have different surface representations or potential for redundancy. That is, among all the nodes constituting the character relation graph, there may be nodes that have an inherently clear uniqueness and do not require separate merging, and conversely, there may also be nodes with a high possibility of redundancy due to the same person's aliases, title-based expressions, or abbreviated names.

The device may first select such merge candidate nodes, and then analyze a correspondence between the candidate nodes to determine whether to merge. The selection of candidate nodes may be performed based on a character string format, a location of appearance, a presence or absence of summary information, a presence or absence of a corresponding candidate in character information, and whether there are repeated connections to a specific important person. For example, nodes marked only by job titles, nodes combined with surnames and job titles, nodes using only part of names, and nodes appearing only as kinship titles may be primarily identified as merge candidates.

As a specific criterion for determining whether there is the same character, the character's name, alias, title, job title, or summary information may be used. The name may include a real name, a combination of surname and given name, an abbreviated name, a variation of foreign and Korean notation. The alias may include a nickname, an alias name, a codename, a stage name, an honorific title, a name used only in a specific relation, and the like. The tile may be an expression indicating a family or social relation, for example, a naming convention such as mother, elder brother, teacher, chief, or CEO. The job title may be an expression indicating an occupational or institutional status, such as professor, prosecutor, team leader, chairman, king, or crown prince.

The summary information may include a person's background, relation, affiliation, role, and association with major events provided in work plans, episode summaries, character introductions, character descriptions, scene outlines, and the like. The device may use these pieces of information individually, or combine two or more pieces to increase the reliability of identity determination.

The determination of identity may first begin with an analysis of the nominal similarity of the candidate nodes. For example, a possibility of merging may increase if part of the same name is shared, if a surname and given name partially match, if a form with and without a job title coexist, or if a real name stated in the character information corresponds to a nickname in the summary.

However, there may be different persons with the same name, family members who share the same surname may be different characters, and the same job title may be commonly applied to multiple persons. Therefore, while nominal similarity can be used as a primary condition for determining merging, it is preferable to also review contextual consistency, similarity of relation patterns, consistency of affiliations and roles, and the existence of the same description in the summary information.

In narrative text, a specific person may appear as a real name in one scene, and in another scene, the same person may be mentioned only as a combination of a job title and a surname. In this case, the device may determine and merge them as a single character if two nodes commonly belong to the same organization, have repetitive relations with the same surrounding characters, and are described as parties to the same event in the summary.

As another example, in a family-centered narrative, a specific person may be referred to as both a real name and a kinship title. In this case, the kinship title alone may cause confusion with several people, but by referring to the family relations stated in the character information and the connection of events in the episode summary together, it is possible to more stably determine whether he or she is the same person.

Once the merging is confirmed, the device may integrate a plurality of nodes into a single representative node. In this case, the representative node may be set to a real name-centered expression, a name that is most frequently used, or a standard name registered in the character information.

Other merged names may be stored as a list of aliases for the representative node or maintained as metadata that can be referenced during subsequent relation extraction and visualization steps. In addition, edges held by each node prior to merging may be reconnected to the representative node, and when edges with the same counterpart node are redundant, the relation types and weights may be organized and integrated into a single relation or a plurality of refined relations.

In addition, the results of identity determination may be processed in a binary operation only as either merged or non-merged, but more preferably, the determination reliability or evidence level may be calculated together and reviewed in a subsequent verification step.

For example, when the name and job title match strongly and the summary information also matches, it may be merged with high reliability, and when only part of the name matches but the surrounding relations are insufficient, it may be left in a pending state and redetermined by referring to additional summary information or the results of relation extraction.

In addition, for nodes expressed solely by titles, since there is a possibility that they may appear as the same person in a specific scene but refer to a different person in another scene, the contextual scope, affiliation information, and event linkage may be reviewed more strictly.

For example, in a medical drama, a person may appear with a real name in one scene, with a combination of a job title of professor and a surname in another, and with a descriptive expression such as a head of a specific department in yet another summary.

The device may determine that all of these expressions correspond to the same person by referring together to a person description stated in the character information, a background setting in the work plan, and an event connection in the episode summary. When merging is performed, colleague relations, hierarchical relations, protective relations, and conflict relations related to a person are concentrated into a single representative node, and thus a narrative position of that character is revealed more accurately.

As another example, in a family narrative, a person may appear with a mixture of a real name, a nickname, a mother title, and a spouse title, and the device may determine whether he or she is the same person by referring to family relations and an event development summary together, and integrate them into a single representative node. Conversely, in the case of siblings or parent-child relations with the same surname, even if parts of the names overlap, they may be maintained as different characters if the summary information and the relation patterns are different.

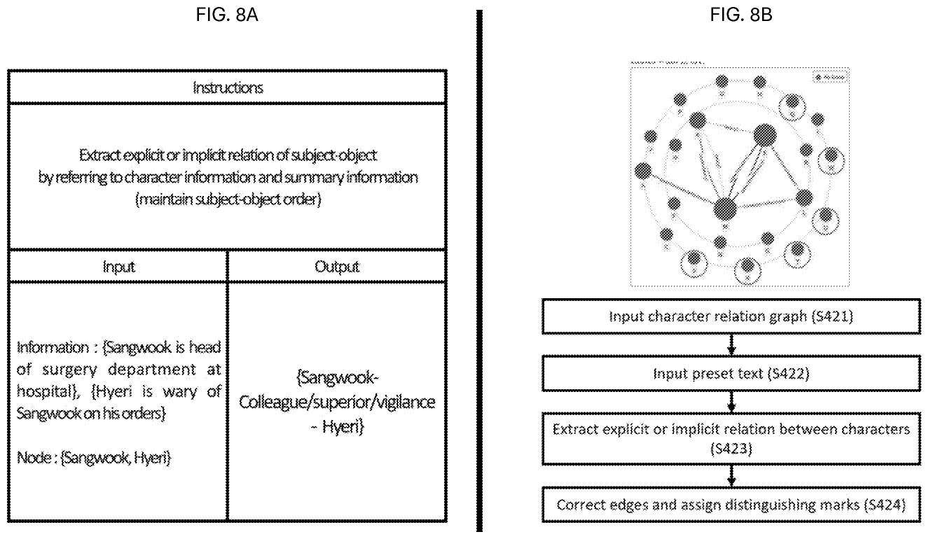

FIGS. 8A and 8B illustrate a process of extracting meaningful relations between a plurality of nodes included in a character relation graph and reflecting the extracted relations as edge information of the graph.

The device may extract at least one of an explicit relation or an implicit relation for at least some pairs of nodes among a plurality of nodes forming a character relation graph. Here, explicit relations may include types of relations that are relatively directly identified or socially accepted within a narrative, and implicit relations may include types of relations interpreted from a narrative context, such as emotional lines, conflict structures, hidden motives, and nuances of repetitive interactions.

The explicit relations may include romantic relations, family relations, friendships, teacher-student relations, or colleague relations. Among these, colleague relations are not treated merely as belonging to the same organization, but may be further subdivided depending on a presence or absence of a hierarchical nature.

For example, it may be embodied as a relation that reflects a hierarchy or role difference within the organization, such as a superior relation, a peer relation, or a subordinate relation. Therefore, even if characters belong to the same organization, when there is an actual work command relation, senior-junior relation, or management-supervision relation, it may be expressed separately from a general colleague relation. This embodiment allows a character relation structure to go beyond a simple connection graph and more accurately reveal a social structure between persons within a narrative.

The implicit relations may be inferred from emotional tension, narrative dynamics, or repetitive interactions between characters.

For example, relations such as conflict, betrayal, infidelity, help, sacrifice, dependence, revenge, resentment, antipathy, worry, unrequited love, affection, love, longing, love-hate, cooperation, regret, exploitation, deception, trust, protection, pressure, conspiracy, or vigilance may fall into this category. In addition, when power structures or political dynamics form the center of the narrative, relations such as support, friendship, or hostility between persons may be additionally included. As such, types of implicit relations may be selectively applied depending on the genre of the narrative, the central conflict structure, and the dynamics between persons.

Such relations are not determined by just one or two lines within the narrative, but rather by comprehensively reflecting the accumulation of events, repeated behavioral patterns, emotional continuity, a direction of development of the narrative, and changes in relations presented in the summary document.

For example, even if there is a scene where a person temporarily helps another, whether it can be viewed as a continuous protective relation or is merely a one-time event needs to be determined based on the narrative as a whole.

Conversely, since implicit relations such as resentment, vigilance, trust, and cooperation may exist separately even among persons who are superficially colleagues or family members, both explicit and implicit relations may be stored for the same pair of nodes.

The device may mechanically extend a target for relation extraction to all possible pairs of nodes, but more preferably, may select pairs of nodes having a substantially high relevance to a main node or an auxiliary node as priority targets.

Relation extraction does not stop at simply adopting a frequency of interaction or co-occurrence information that already existed in a basic graph. A large language model in the refinement step may refer to auxiliary documents such as work plans, episode summaries, and character information to determine whether a meaningful relation actually exists between a specific pair of nodes, and if so, what type it is and what a directionality of the relation is.

For example, when one person is a superior of another, a relation between the superior and the subordinate may vary depending on the order of the pairs of nodes, and therefore it is preferable to store the relation extraction in the form of a directional edge. That is, a superior relation may be assigned in one direction, and a subordinate relation in the opposite direction.

Similarly, implicit relations that can be mutually asymmetric, such as protection and dependence, trust and vigilance, and love and resentment, may also be stored in consideration of their directionality. Such directional processing allows the character relation structure to be expressed closer to an actual narrative.

When extracting relations, a step of verifying whether the directionality between the subject and object of the extracted relation is correctly set may be further performed. Here, the directionality refers to whether a specific relation is established from which node to which node. Among explicit relations, family and hierarchical colleague relations differ in meaning depending on the directionality, so it is particularly important to verify the directionality thereof.

For example, when a character is an elder sibling of another character, an elder sibling relation should be assigned in a direction where that character is a subject and a younger sibling character is an object. Conversely, in a direction where a younger sibling character is a subject, a younger-sibling relation must be assigned. When an expression referring to a family relation varies depending on the perspective, the device may review whether that expression is accurate from the standpoint of a subject node to which the relation is assigned, and correct the direction if an error is found, or reassign a relation to that pair of characters in respective directions.

Similarly, in a hierarchical colleague relation, an error may occur where a subordinate relation is assigned to a node to which a superior relation should be assigned, or vice versa. For example, when character A is a superior of character B, it is correct to assign a superior relation in a direction with character A as a subject, and a subordinate relation in a direction with character B as a subject, respectively. The device may detect and correct such directional errors by cross-reviewing the extracted relation and character information with an organizational structure or role relation stated in the episode summary.

The directional verification may be performed independently or integrated as part of a refinement error verification process described in step (d-9). Relation information modified through directional verification may also be consistently utilized in subsequent role identification and group classification steps.

In addition, when extracting relations, it is preferable to include criteria for distinguishing between temporary events and essential relations. Assigning a long-term conflict or protective relation to a character solely because a character collides or helps just once in a specific scene may distort the resulting structure. Therefore, the validity of the relation may be determined in consideration of its repetitiveness, continuity, narrative importance, whether it is re-mentioned in the summary document, and consistency with the basic settings in the work plan.

For example, temporary cooperation may be treated at a level of simple events, and mutual support repeated over multiple episodes may be promoted to a cooperative or trust relation. Conversely, momentary arguments are left only as individual events, and conflict or retaliatory relations may be assigned only when continuous confrontation or a retaliatory structure accumulates.

For example, in a medical narrative, two persons belong to the same department within the hospital organization, but in reality, they may be in a relation as a supervising professor and a resident. In this case, the device may extract a teacher-student relation or a hierarchical colleague relation as an explicit relation, and at the same time, may extract trust, pressure, vigilance, or protection as an implicit relation.

As another example, in a family-centered narrative, family relations such as spouses, parents and children, and siblings may be extracted as explicit relations, and implicit relations such as love, resentment, dependence, conflict, and sacrifice may be overlapped and stored for the same pair of nodes or adjacent pairs of nodes.

In a melodrama, implicit relations such as longing, betrayal, love, deception, cooperation, or conspiracy may be formed on top of explicit relations such as lovers or friends, and in a crime or political narrative, implicit relations such as pressure, conspiracy, vigilance, trust, and revenge may be added on top of colleague or hierarchical relations.

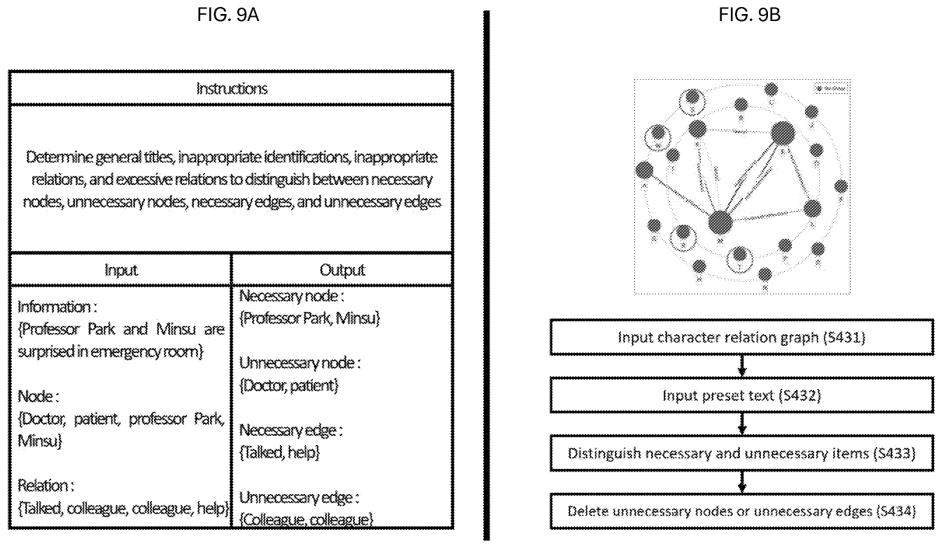

FIGS. 9A and 9B illustrate a process of selecting and removing nodes that do not substantially contribute to the core understanding of the narrative among a plurality of nodes included in a character relation graph.

For each node constituting the character relation graph, the device may determine whether that node has a substantial effect on the development of the narrative. Here, unnecessary nodes that have no effect on the narrative may include expressions that perform only an auxiliary function of the scene or are mentioned only once, without contributing to the central conflict of the narrative, major events, the continuous formation of character relations, the accumulation of emotional lines, or the understanding of the role structure.

Such nodes may be temporarily extracted like entities during text processing, but when retained in the actual character relation structure, unnecessary complexity may be caused and temporary interactions with surrounding people may be mistaken as if they were meaningful relations.

Representative examples of unnecessary nodes include general titles or pronoun-like names. The general titles may mean expressions that vaguely refer only to a group of roles or occupations, rather than stably identifying a specific individual person.

For example, expressions such as patient, guest, staff, secretary, driver, professor, doctor, nurse, detective, and student may refer to actual individual characters depending on the context, but in many cases, they may be limited to referring to scene persons with temporary functions. The pronoun-like names may include expressions with weak unique identifiability, such as that person, she, that man, that woman, and this person.

Such expressions may help interpret the referents within the context, but there are often cases where they do not need to be retained as individual nodes in the final relation structure. Therefore, when a general title or a pronoun-like name is extracted as an independent node, it may be determined whether to remove it after reviewing whether the node has sufficient narrative core and individual identification.

However, it is not limited to a configuration that mechanically removes both general titles or title-based expressions. This is because some expressions, even if they appear outwardly like job titles or general titles, may actually be used as unique identifiers to stably refer to a specific character.

Expressions combining a surname and a job title, fixed titles combined with a specific organization, and separate titles referring exclusively to a specific person may function as actual individual characters within a narrative.

The removal of unnecessary nodes may be performed by using only simple string rules, but more preferably, may be performed by a method of synthesizing a plurality of determination elements.

The device may review a name type of that node, whether it is a unique name, whether it includes a surname, whether a corresponding item exists in character information or a summary, a continuity of the relation with the main node, a frequency of appearance, a repetition between episodes, a possibility of role identification, and a possibility of group classification.

If a specific node has a general title but appears only in limited scenes, its relation with other key persons remains at a level of one-time contact, and there is no separate description items in the character information or summary, the node is highly likely to be determined as a target for removal.

Conversely, even if it appears to be a general title, when it has a long-term relation with a main node, is repeatedly described as a party to the same event in the summary, or has a distinct function in subsequent role identification, it may be maintained initially and then redetermined in conjunction with other refinement steps.

For example, in medical narratives, expressions such as patients, guardians, guests, paramedics, and drivers may frequently appear in emergency room or ward scenes. Some of these may be merely functional persons serving to initiate a simple event, and may not reappear after a specific scene. In this case, the device may determine the node to be unnecessary and remove it when that node is not identified by an individual name, does not form a continuous relation with a main person, and has no separate description in the summary or character information.

However, even if the expression “patient” is used in the same way, when a specific patient is connected to the protagonist's internal change, important secrets, or long-term conflicts of the events, it may be maintained rather than viewed as a mere general title.

As another example, in a family-centered narrative, multiple titles such as mother, father, older brother, older sister, teacher, and boss may appear. Some of these expressions may function as unique titles that stably indicate specific characters, while others may be ambiguous descriptive expressions that vary depending on the situation or appear only briefly in specific scenes.

In this case, the device may distinguish whether that title is a fixed identifier connect to a real name or alias, or a descriptive expression in a simple conversational context, by referring to character information and a summary. If it falls under the latter category and has a weak connection to major events, it may be regarded as a target for removal.

On the other hand, if the same title repeatedly refers to the same person and forms a core axis of the family relation structure, it is preferable to maintain it. As such, this step operates in a direction that makes the narrative structure clearer, rather than through excessive reduction.

Along with the removal of unnecessary nodes, edge cleanup resulting from the removal may also be performed. That is, when a specific node is removed, the edges connected to that node are deleted along therewith, or, if necessary, may be removed after being reflected in a higher relation summary.

For example, if a temporary contact edge was formed between a one-time scene person and a main person, the edge may also be deleted along with the removal of that node. Furthermore, even if the removed node appeared to serve as a channel for transferring substantial relations with other nodes, it may be preferable to remove it without separate relation succession if it is irrelevant to the core of the narrative.

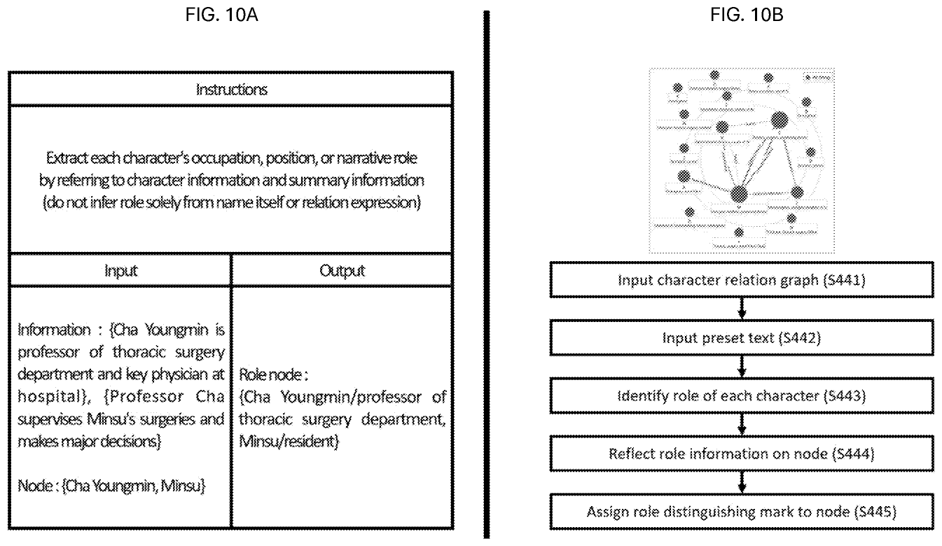

FIGS. 10A and 10B illustrate a process of extracting the role of a character for each node included in a character relation graph and adding the extracted role so as to correspond to the node.

The device may extract a role for each node of the character relation graph. Here, the role may include at least one of an occupation, position, or narrative-specific role.

The occupation may be information indicating actual duties or occupational groups, such as doctor, intern, resident, or sanitation officer. The position may be information indicating status or hierarchy within an organization, such as a manager, chairman, or successor. The narrative-specific role may refer to a person's distinctive position within the story that cannot be fully explained by his or her simple occupation or position alone.

For example, this may be a case where a narrative function beyond a simple occupation plays a significant role, such as when a specific person is the chairman of a foundation and simultaneously the mother of a specific key person, a doctor and simultaneously a person in a state of being possessed, or a head of administration and a cousin of a central person.

Role extraction may be performed only by a basic graph itself, but more preferably, may be performed by referring to auxiliary text such as a work plan, an episode summary, and character information together. This is because a character relation graph alone may not sufficiently reveal what occupation a specific character has, what position he or she holds, or what special narrative position he or she occupies.

Even if a node is strongly connected to a central person, it may not be fully identified from the graph's edge information alone whether that person is a mere colleague, a supervising professor, a hospital management member, a family member, or an instigator of an event. In this case, the device may determine the role name by referring to the introduction phrase stated in the character information, the person description in the work plan, and the event outline in the episode summary.

When extracting roles, it is preferable not to misunderstand the role only in the form of a simple name. It may be inaccurate to immediately adopt a name as a role simply because it sounds like an occupation or an alias implies a specific function. Furthermore, relation expressions such as someone's wife, someone's daughter, or someone's friend are relational information and need to be distinguished from intrinsic role information.

However, it is possible to include familial or functional descriptions alongside occupation or position to explain a specific person's narrative position. For example, expressions such as the mother of a specific key person as the chairman of a foundation or the youngest daughter of a specific person as a neurosurgeon do not merely describe a simple relation, and may be understood as a way to help interpret the role by combining occupational information with narrative identification information.

Only one role may be assigned, or a plurality of elements may be assigned in a combined form as needed.

For example, when the occupation of “doctor” alone is insufficient to fully express that person's position, more specific role names may be used, such as a thoracic surgeon, an emergency room intern, a head of thoracic surgery, or an administrative chief.

For example, when processing a medical narrative, the device may extract from character introduction documents and episode summaries whether a specific person is an emergency room intern, a thoracic surgeon, a resident, the chairman of a hospital foundation, a head of administration, or a patient.

In this process, it does not stop at a level of simply being a hospital person, but may also reflect which department he or she belongs to, what the training step he or she has, and what a special narrative condition he or she has.

For example, even if there are two persons who appear to be doctors in the same way, one person may be a thoracic surgeon and a key person in a possession state, while the other may be an emergency room intern and a supporting person mediating an event.

As another example, since occupational information may be scarce in a family-centered narrative, roles may be extracted based on narrative-specific roles such as a position within the family, a representative of the clan, an heir, a protector, a guardian, a family member of a missing person, and a witness to an event.

In a political or corporate narrative, position-centered roles such as chairman, representative, director, successor, chief of staff, advisor, prosecutor, and investigator may be valid, while in a school narrative, roles such as professor, homeroom teacher, student council president, transfer student, and scholarship student may be valid.

In addition, the reliability of the role or the basis for extraction may also be managed together. When both character information and summary match and support a specific role, it may be recorded as a high-reliability role, and a role implied only in some contexts may be subject to subsequent verification or designated as a provisional role.

When there are a plurality of role candidates, a representative role may be selected based on which information is more significant for narrative interpretation among occupation, position, or narrative-specific role. In the drawing, one role box is connected to a single node, but internally, a method of storing a plurality of candidates and then selecting only the representative role for a final mark may also be allowed.

As described above, according to the configuration of the drawing, occupation, position, or narrative-specific role may be extracted and added to each node of the character relation graph, thereby forming a more interpretable character relation structure that expresses not only the relations between characters but also the identity and functional position of each person.

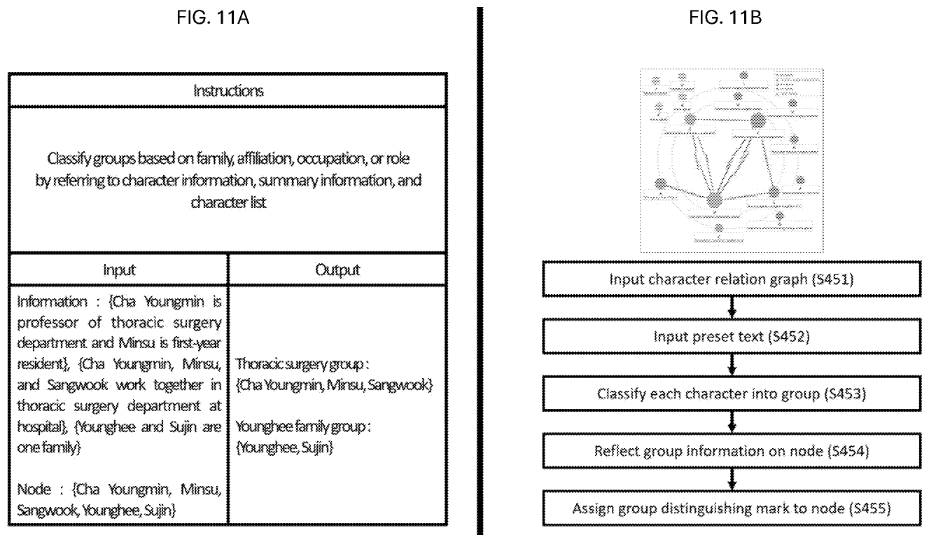

FIGS. 11A and 11B illustrate a process of classifying a plurality of nodes included in a character relation graph into groups according to a predetermined criterion, and reflecting the classification result together in the visual mark and structural metadata of the graph.

The device may classify a plurality of nodes of a character relation graph into groups. Here, the groups may be formed based on at least one of family, affiliation, occupation, or role.

Family reference groups may be formed around familial bonds, such as parents, children, spouses, siblings, and kinship units. Affiliation reference groups may be formed around affiliation with specific organizations or institutions, such as companies, departments, hospital divisions, schools, investigative agencies, family organizations, political groups, and secret organizations. Occupation reference groups may be formed by a method of grouping characters belonging to similar occupational groups, such as a doctor group, a student group, a lawyer group, and a criminal group. Role reference groups may be formed around narrative functional positions, such as successor groups, guardian groups, management leader groups, and event-related character groups.

Group classification is not only performed by a degree of simple connection between nodes, but is preferably performed by referring to auxiliary text such as relation information, role information, a work plan, an episode summary, and character information extracted in a previous step.

For example, even if some persons have a high frequency of interaction, a separate interpretation is needed as to whether they are in the same family, belong to the same department, or are temporarily entangled in the same event. In this case, the device may analyze character information specifying family relations, planning documents explaining character backgrounds, and episode summaries summarizing the development of events together to determine whether to group those characters into a single family group, an organization group, or a separate role-based group.

The group classification may be performed by a method of assigning one representative group to each character. This is because, even if a single person may have a plurality of affiliations or relations simultaneously, arranging them around a most meaningful group in the final visualization and structuring results increases the readability of the overall graph.

For example, a person may be both a family member and a hospital member, but in a specific narrative, its position within the family may be more important, while in another, its role within the organization may be more important. In this case, the device may determine a representative group by referring to the central theme of the work, the weight of the development of events, the density of the relation axis, the priority of explanation of auxiliary documents, and the like.

However, it is also possible to maintain additional group information separately in the internal data structure, and to mark only representative groups in the visualization step. This method is advantageous for minimizing information loss while clearly maintaining the core group structure necessary for narrative understanding.

For example, in a medical narrative, a department-based affiliation group consisting of doctors, residents, interns, and managers can be formed. In this case, persons belonging to the same medical department may be classified into a single affiliation group, while foundation officials or family members outside the hospital may be classified into a different group. At the same time, persons who have direct blood ties or marital relations with the protagonist may be grouped separately as a family group.

In addition, in a case where special settings exist that are difficult to explain using general hospital or family organizations, such as a set of persons in an abnormal state connected by a specific event or a set of persons forming an independent narrative category, they may be established as a separate role-based group. A special group marked in the drawing may also be understood as such an example.

As another example, in a family-centered narrative, group classification may be centered on family relations. Parents and children belonging to the same family, as well as spouses and their surrounding relatives, may be grouped into a single family group, while workplace colleagues or groups of friends may be established as separate auxiliary groups.

Conversely, in workplace-centered dramas or crime dramas, affiliation criteria may take precedence. For example, persons belonging to the same investigation team, the same department, the same corporate line, or the same legal organization form a group, and family groups may be maintained incidentally.

Group classification may be performed by varying the priority of grouping criteria according to the central theme or structural characteristics of the narrative. For example, in a narrative centered on a workplace or organization, persons' affiliation organizations, departments, or professional roles may be used as primary criteria for grouping. In this case, persons assigned to different departments or teams may be preferably separated into individual groups even if they belong to the same organization, and a department-based subdivided group name may be assigned, thereby more clearly expressing a relation structure within the organization.

On the other hand, in a narrative centered on family relations, blood ties, marriage, or familial bonds may be used as primary grouping criteria. In this case, when a person is a member of a specific organization and a family member of a main person at the same time, the family group may be applied first as the representative group if the weight of the role in that narrative is in a family relation. In addition, small family groups with few members, such as mother-child or marital relations, may also be established as independent family groups.

The device may determine whether that narrative is workplace/organization-centered or family-centered by referring to the work plan, episode summary, or character information, and automatically adjust the priority of grouping criteria based on a result of the determination. For example, when a specific department or organization is specified as a main background of the narrative in the work plan, or when the majority of the characters are stated as the same organization affiliation, the affiliation criteria may be applied preferentially. Conversely, when family relations are described as a core axis of the narrative in person introduction materials, or when main persons are primarily connected by marriage or blood ties, the family relation criteria may be applied preferentially.

Priority-based group classification that reflects narrative types may be performed in this way, thereby consistently applying the same group classification algorithm to narratives of various genres and structures as well as generating a natural group classification result that corresponds to the characteristics of each narrative.

The group name itself may be preferably set as specifically as possible. For example, rather than simply marking them as a family or hospital group, specific names may be assigned, such as a family group centered on a specific person, a group corresponding to a specific department name, or a group corresponding to a specific organization name.

By doing this, even if a plurality of family groups or organizational groups exist within the same story, they may be easily distinguished from one another. In the drawings as well, individual group names are specifically stated in the legend, thereby clearly revealing the identities of different groups.

In addition, persons who do not naturally belong to any group may maintain a non-group status. The non-group mark prevents all characters from being forcibly grouped, thereby actually increasing the reliability of the classification results.

Meanwhile, group classification does not need to be performed entirely automatically, and if necessary, initial reference groups provided by users or operator review results may be utilized as supplementary information.

If a producer or reviewer designates a specific group of people in advance as a core family group or core organization group, the device may expand and classify surrounding nodes based thereon. Alternatively, a method of checking only the representative group by a human for the automatic classification result and automatically assigning the detailed nodes may also be allowed.

Although specific embodiments of a method for generating a character relation structure and a system for the same according to the present disclosure have been described above, the present disclosure is not limited to the embodiments. Various modifications, changes, additions, or substitutions can be made by those skilled in the art without departing from the technical concept and essence of the present disclosure, and all such modified embodiments should also be interpreted as being included in the scope of the rights of the present disclosure.

### DESCRIPTION OF SYMBOLS

10: Narrative text 11: Training text 20: Chunk
21: Training chunk 30: Triple structure 31: Training triple structure
40: Character relation graph 50: Character relation structure 60: Training dataset
70: Preset text 100: Large language model 101: Large language model
102: Large language model 200: Pre-trained language model 201: Preset language model
300: Large language model

What is claimed is:

1. A method for generating a character relation structure performed by a device comprising a central processing unit and a memory, the method comprising:
(a) receiving narrative text;
(b) dividing the text into a plurality of chunks;
(c) extracting triple structures from the chunks to generate a character relation graph;
(d) sequentially inputting the character relation graph into a plurality of large language models, but inputting an output of each large language model into a next large language model to refine character relation information; and
(e) generating a character relation structure from the refined character relation information,
wherein the triple structure is a structure in the form of subject-predicate-object.

2. The method of claim 1, wherein the chunks of the step (b) are units of tokens with a preset length.

3. The method of claim 1, wherein the character relation graph of the step (c) uses an entity selected based on a subject and an object of the triple structure as a node, and uses a relation selected based on a predicate of the triple structure as an edge.

4. The method of claim 1, wherein the step (c) further comprises: (c-1) inputting the chunks into a pre-trained language model to extract triple structures.

5. The method of claim 4, wherein the pre-trained language model used in the (c-1) step is prepared through a training process comprising:
(c-1-1) dividing a plurality of training texts into training chunks;
(c-1-2) inputting the training chunks into a large language model to extract training triple structures;
(c-1-3) generating a training dataset comprising the training chunks and the training triple structures; and
(c-1-4) training a preset language model using the training dataset.

6. The method of claim 1, wherein the step (d) further comprises:
(d-1) additionally inputting preset text into a plurality of large language models, and
wherein the preset text input by the step (d-1) comprises at least one of a work plan, a summary, or character information.

7. The method of claim 1, wherein the step (d) further comprises:
(d-2) determining each node in the character relation graph as a main node or an auxiliary node according to its frequency of appearance or importance.

8. The method of claim 1, wherein the step (d) comprises:
(d-3) merging a plurality of nodes referring to the same character in the character relation graph, and
wherein the step (d-3) determines whether there is the same character based on at least one of the character's name, alias, title, job title, or summary information.

9. The method of claim 1, wherein the step (d) comprises:
(d-4) extracting at least one of an explicit relation or an implicit relation between a plurality of nodes from the character relation graph,
wherein the explicit relation of the step (d-4) comprises:
at least one of a romantic, family, friend, teacher-student, or colleague relation,
wherein the colleague relation of the explicit relation comprises:
at least one of a superior, a peer, or a subordinate, and
wherein the implicit relation of the step (d-4) comprises at least one of conflict, betrayal, help, sacrifice, dependence, revenge, resentment, love, longing, cooperation, deception, trust, protection, pressure, conspiracy, or vigilance.

10. The method of claim 1, wherein the step (d) comprises:
(d-5) removing an unnecessary node that does not affect a narrative from the character relation graph, and
wherein the unnecessary node in the step (d-5) comprises:
a general title or a pronoun-like name.

11. The method of claim 1, wherein the step (d) comprises:
(d-6) extracting the role of each node in the character relation graph, and
wherein the role of the step (d-6) comprises:
at least one of an occupation, position, or narrative-specific role.

12. The method of claim 1, wherein the step (d) comprises:
(d-7) classifying a plurality of nodes into groups in the character relation graph, and
wherein the group of the step (d-7) comprises:
at least one of family, affiliation, occupation, or role.

13. The method of claim 1, wherein the step (d) further comprises:
(d-8) modifying an output of each large language model to match an input structure of a next large language model.

14. The method of claim 1, wherein the step (d) further comprises:
(d-9) verifying whether there is a refinement error for every output of a plurality of large language models.

15. The method of claim 1, wherein the step (e) further comprises:
(e-1) outputting the character relation structure in the form of a graph, but assigning at least one distinguishing mark such as color, size, or label to a node and edge.

16. A character relation structure generation system comprising a central processing unit and a memory, the system comprising:
a text input part that receives narrative text;
a chunk division part that divides the text into a plurality of chunks;
a graph generation part that extracts a triple structure from the chunks to generate a character relation graph;
a character relation information refinement part that sequentially inputs the character relation graph into a plurality of large language models, but inputs an output of each large language model into a next large language model to refine character relation information; and
a structure generation part that generates a character relation structure from the refined character relation information,
wherein the triple structure is a structure in the form of subject-predicate-object.

17. The system of claim 16, wherein the graph generation part further comprises:
a triple structure extraction part that inputs the chunks into a pre-trained language model to extract a triple structure.

18. The system of claim 16, wherein the character relation information refinement part further comprises:
an additional input part that additionally inputs preset text into a plurality of large language models, and
wherein the preset text input by the additional input part comprises at least one of a work plan, a summary, or character information.

19. The system of claim 16, wherein the character relation information refinement part comprises at least one of:
a node determination part that determines each node in the character relation graph as a main node or an auxiliary node according to its frequency of appearance or importance;
a node merging part that merges a plurality of nodes referring to the same character in the character relation graph;
a node relation extraction part that extracts at least one of an explicit relation or an implicit relation between a plurality of nodes from the character relation graph;
a node removal part that removes an unnecessary node that does not affect a narrative from the character relation graph;
a node role extraction part that extracts the role of each node from the character relation graph; and
a node classification part that classifies a plurality of nodes into groups in the character relation graph.

20. The system of claim 16, wherein the structure generation part further comprises:
a distinguishing mark assignment part that outputs the character relation structure in the form of a graph, but assigns at least one distinguishing mark such as color, size, or label to a node and edge.
